(19) United States
(12) Patent Application Publication
(10) Pub. No.: US 2011/0017331 A1
(43) Pub. Date: Jan. 27, 2011

(54) Hydraulic Supply System

(75) Inventor: Cedric Deman, Savignies (FR)

Correspondence Address: AGCO Corporation, Legal Department, 4205 River Green Parkway, Duluth, GA, 30096, US

(73) Assignee: AGCO SA, Beauvais (FR)

(21) Appl. No.: 12/745,662

(22) PCT Filed: Dec. 4, 2008
(86) PCT No.: PCT/EP2008/010270

§ 371 Date: Oct. 12, 2010

(30) Foreign Application Priority Data
Dec. 8, 2007 (GB) 0723990.8

(51) Int. Cl. B60R 16/08

(52) U.S. Cl. 137/899; 137/565.11

(57) ABSTRACT

A hydraulic supply system (10) for a tractor is provided comprising a hydraulic pump (P) and a support plate (13) mounted on the exterior of a tractor chassis (14). One or more fluid flow control valves (17a,17b, 17c,27,28,29,31) or other consumers are mounted on the support plate (13) which are fed with fluid from the pump (P) via passages (12a,12c) in the support plate. The separate support plate reduces the number of hydraulic pipes required thereby improving space availability and assembly costs.

This invention relates to hydraulic supply systems and in particular to systems used to supply hydraulically operated functions on an agricultural tractor or similar vehicle.

Traditionally in such supply systems one or more pumps supply pressurised fluid to the functions via fluid flow control valves and the pumps, control valves and functions are interconnected via hydraulic pipes. This can cause problems when this piping is mounted on the outside of a tractor chassis which is conventionally provided by a series arrangement of an engine block, transmission housing and back axle assembly on top of which a tractor cab is mounted. This leads to a lack of space between the cab and chassis to receive this piping. Also such piping is costly to provide and install.

It is an object of the present invention to provide a hydraulic supply system for use in a tractor which help to alleviate the above piping problems.

Thus in accordance with the present invention there is provided a hydraulic supply system comprising a hydraulic pump, a support plate mounted on the exterior of a tractor chassis, one or more fluid flow control valves or other consumers mounted on the support plate which are fed with fluid from the pump via passages in the support plate. By providing a separate plate which comprises a plurality of bores to convey pressurised fluid, the quantity of piping is reduced thus increasing the available space for components and simplifying assembly.

The support plate also preferably includes the other passages through which return flow from the or each flow control valve or consumer flows.

A number of external hydraulic connectors may also be mounted on the support plate which receive fluid from the pump via passages in the plate.

The fluid from the pump may be supplied from the pump to the support plate via a priority flow valve which ensures that vital functions receive sufficient fluid flow from the pump.

In a preferred arrangement the tractor chassis comprises a transmission casing and the support plate is mounted on the casing in a spaced relationship. This allows the a consumer to be mounted to the underside of the support plate thereby exploiting the available space defined by the profile of the transmission casing.

One embodiment of the present invention will now be described, by way of example only, with reference to the accompanying drawings in which:

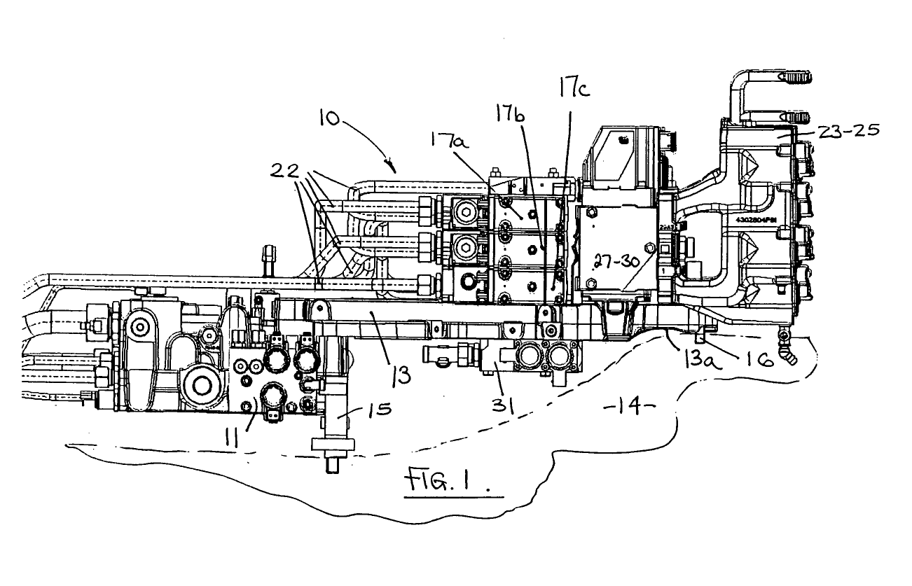

FIG. 1 shows a side view of a hydraulic supply system in accordance with the present invention;

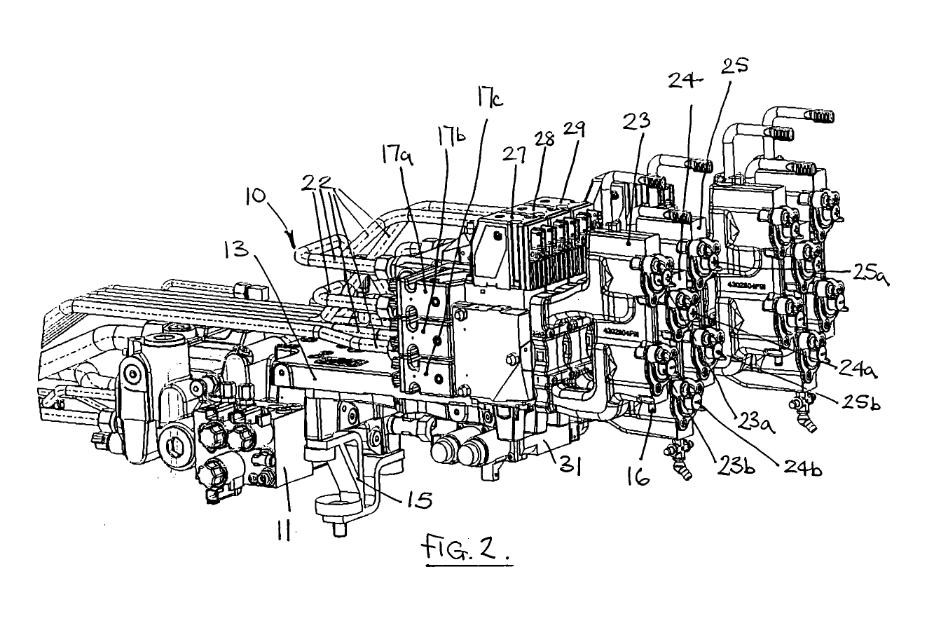

FIG. 2 shows FIG. 1 in perspective, and

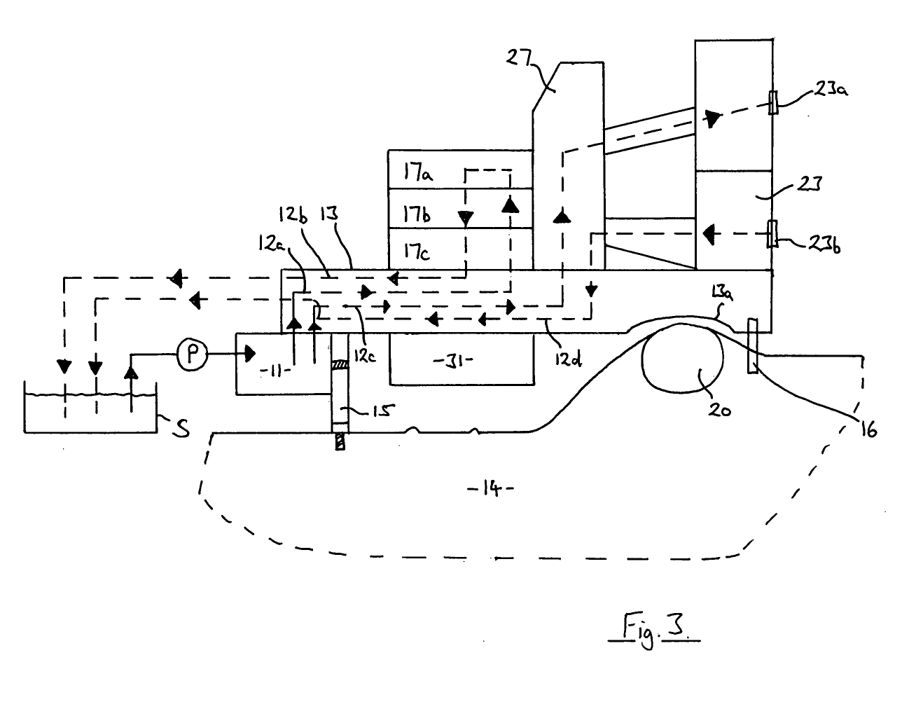

FIG. 3 shows diagrammatically details of the hydraulic supply system of the present invention.

Referring to the drawings, a hydraulic supply system 10 for a tractor comprises a source of hydraulic pressure in the form of a hydraulic pump P (see FIG. 3) which is connected via priority valve 11 with passages 12 provided in a support plate 13 which is mounted on the top of a tractor chassis 14 by mounting brackets 15 in a spaced relationship. The support plate has a curved portion 13a which extends over the cross shaft 20 of the rear hitch (not shown) of the tractor and is also mounted towards its rear on the chassis by a fixing 16.

During assembly, the support plate can be mounted to the chassis 14 before attaching the various consumers and valves.

Mounted on the support plate 13 are hydraulic control valves 17a, 17b and 17c which are connected with pressurised fluid from the pump P via a passage 12a formed in the plate 13, the return flow from valves 17a, 17b and 17c travel via passages 12b to a sump S of the system.

These control valves 17a, 17b and 17c may be used to control the flow of pressurised fluid to a variety of consumers via pipes 22. Also mounted on plate 13 are external hydraulic connectors three of which are numbered 23 to 25. Each connector 23 to 25 includes outlets 23a, 23b:24a, 24B: 25a, 25b for use with single or double acting external consumers in the conventional manner. The flow to these external connectors are controlled by solenoid operated valves 27 to 29 respectively which are fed with pressurised fluid from priority valve 11 via passage 12c in plate 13. The return flow from valves 27 to 29 travels via passage 12d to sump S.

The spaced relationship and the profile of the underlying chassis allows a further consumer in the form of a solenoid operated valve 31 to be mounted below plate 13. Valve 31 also receives pressurised fluid from pump P via valve 11 and returns fluid to sump S via passages in plate 13.

Priority valve 11 ensures that vital hydraulically operated functions such as steering and trailer braking are always supplied with sufficient flow of fluid to ensure their correct operation.

The present invention thus provides a hydraulic supply system for a tractor or similar vehicle in which certain valves or other consumers are supplied with pressurised fluid and have their return flow routed to the sump via passages in a plate on which consumers or control valves are mounted thus reducing the amount of piping required on the tractor. The support plate 13 replaces numerous pipes which increases available space and improves assembly time and cost.

1. A hydraulic supply system comprising:
a hydraulic pump;
a support plate mounted on the exterior of a tractor chassis; and
one or more fluid flow control valves or other consumers mounted on the support plate which are fed with fluid from the pump via passages in the support plate.

2. A system according to claim 1 in which fluid is returned from the or each flow control valve or other consumer via other passages in the support plate.

3. A system according to claim 1, in which a number of external hydraulic connectors are also mounted on the support plate which receive fluid from the pump via passages in the plate.

4. A system according to claim 1, in which fluid from the pump is supplied to the support plate via a priority flow valve which ensures that vital functions receive sufficient fluid flow from the pump.

5. A system according to claim 1, wherein the tractor chassis comprises a transmission casing, and wherein the support plate is mounted on the casing in a spaced relationship.

6. A system according to claim 5, wherein a consumer is mounted to the underside of the support plate.

7. A system according to claim 2, in which a number of external hydraulic connectors are also mounted on the support plate which receive fluid from the pump via passages in the plate.

8. A system according to claim 2, in which fluid from the pump is supplied to the support plate via a priority flow valve which ensures that vital functions receive sufficient fluid flow from the pump.

9. A system according to claim 3, in which fluid from the pump is supplied to the support plate via a priority flow valve which ensures that vital functions receive sufficient fluid flow from the pump.

10. A system according to claim 2, wherein the tractor chassis comprises a transmission casing, and wherein the support plate is mounted on the casing in a spaced relationship.

11. A system according to claim 3, wherein the tractor chassis comprises a transmission casing, and wherein the support plate is mounted on the casing in a spaced relationship.

12. A system according to claim 4, wherein the tractor chassis comprises a transmission casing, and wherein the support plate is mounted on the casing in a spaced relationship.
